(19) United States
(12) Patent Application Publication
(10) Pub. No.: US 2017/0034551 A1
(43) Pub. Date: Feb. 2, 2017

(54) DYNAMIC SCREEN REPLICATION AND REAL-TIME DISPLAY RENDERING BASED ON MEDIA-APPLICATION CHARACTERISTICS

(71) Applicant: GM GLOBAL TECHNOLOGY OPERATIONS LLC, DETROIT, MI (US)

(72) Inventors: FAN BAI, ANN ARBOR, MI (US); DAN SHAN, WARREN, MI (US); DONALD K. GRIMM, UTICA, MI (US); MASSIMO OSELLA, TROY, MI (US)

(73) Assignee: GM GLOBAL TECHNOLOGY OPERATIONS LLC

(21) Appl. No.: 14/812,025

(22) Filed: Jul. 29, 2015

(51) Int. Cl. H04N 21/2343; H04N 21/4402; H04N 21/437; H04N 21/414

(52) U.S. Cl. CPC H04N 21/234309; H04N 21/41407; H04N 21/440218; H04N 21/437

(57) ABSTRACT

A portable system including a processor and a storage device comprising computer-executable code that, when executed by the processor, causes the processor to perform various operations including receiving visual media content from a source, and determining an application characteristic selected from a group consisting of an application identity and an application category associated with a subject application stored at the portable system and/or at a host device in communication with the portable system. The operations further include determining, based on the application characteristic, which of multiple available codecs a host device should use to process the visual content, sending, to the host device, a communication indicating the codec for use in processing the visual content, and sending the visual content to the host device for display rendering using the codec determined.

### TECHNICAL FIELD

The present disclosure relates generally to systems and methods for transmitting media content and more particularly to systems and methods for replicating and real-time display rendering visual media based on a characteristic of a subject media application.

### BACKGROUND

Most modern automobiles are equipped by original equipment manufacturers (OEMs) with infotainment units that can present audio and visual media. The units can present audio received over the Internet by way of an audio application running at the unit, and present video received from a digital video disc (DVD), for instance. While many units can also present visual media received from a remote source, such as navigation and weather information, presenting video received from a remote source remains a challenge.

Other display devices, such as televisions and computer monitors, can receive video data by way of a high-transfer-rate interface such as a High-Definition Multimedia Interface (HDMI) or Video Graphics Array (VGA) port. (HDMI is a registered trademark of HDMI Licensing, LLC, of Sunnyvale, Calif.) Digital media routers have been developed for plugging into these high-throughput, or high-transfer-rate ports for providing video data to the display device.

Barriers to transferring and real-time display rendering video data efficiently and effectively from a remote source to a local device for display also include limitations at the local device, such as limitations of legacy software and/or hardware at the local device. For example, universal-serial-bus (USB) video class (UVC) is not supported by either commercial ANDROID® devices or prevailing infotainment systems. (Android is a registered trademark of Google, Inc., of Mountain View, Calif.)

Most modern host devices, such as legacy automobiles already on the road, do not have these high-transfer-rate interfaces. Increasingly, modern vehicles have a peripheral port, such as a USB port, or wireless receivers for relatively low-rate data transfer from a mobile-user device such as a smart phone. Often, the phones do not have a video card and/or the vehicles do not have graphics processing hardware.

Streaming video data efficiently and effectively by way of a lower transfer-rate connection, such as a peripheral port, e.g., USB connection, is a challenge either because the transfer rate is too slow, or the plugged-in device or host device (e.g., legacy vehicle or television) does not have the required video graphics hardware and/or software. Streaming video data conventionally requires high data rates. While HDMI data rates can exceed 10 Gbps, USB data rates do not typically exceed about 4 Gbps.

### SUMMARY

There is a need for an arrangement that can transfer and display render or display replicate in real time efficiently high-speed video streams from a portable mass-storage system to a host device for display rendering with low latency as high-quality video, using a relatively low-rate connection, such as a USB connection.

The present technology solves these and other challenges related to transferring and real-time display rendering or replicating high-throughput media received from a source, such as a remote application server, to a destination host device, such as an automobile head unit.

The present disclosure relates to a portable system including a processor and a storage device comprising computer-executable instructions or code that, when executed by the processor, cause the processor to perform various operations including receiving, using the application, media content from a source, such as a third-party application server. The operations further include determining an application characteristic selected from a group consisting of an application identity and an application category associated with a subject application.

The operations also include determining, based on the application characteristic, which of multiple available codec families a host device should use to process the visual content, such as a lossless codec or a lossy codec. An indication of the codec family selected and the visual content are sent to the host device for display rendering using the codec determined.

In one embodiment, the operations include determining, based on the application characteristic, which of multiple available codec parameters to use in processing the visual content, such as compression ratios and resolution levels. The operations include sending to the host device a communication indicating the codec parameter to be used in processing the visual content at the host device.

The portable system can have stored, thereat, identifiers corresponding to the available code families and/or the available codec parameters. The memory 112 can include mapping data relating each application characteristic to an available codec families, and/or at least one of the available codec parameters, for use in determining the appropriate codec family and codec parameter(s) in each situation.

In various embodiments, the host device is part of an automobile comprising a universal serial bus (USB) port or any variant, such as wireless USB, and the portable system comprises a USB plug or wireless interface for mating with the automobile.

In another aspect of the present technology, the host device includes a processor configured to communicate with a communication port and a display screen device, and perform various operations, including receiving, from the portable system, a communication indicating (i) a codec determined at the portable system based on an application running at the portable system, and (ii) a codec parameter also selected at the portable system based on the application.

The operations of the host device further include receiving visual content from the portable system, and processing the visual content using the codec and/or the codec parameter received, yielding processed visual content.

The portable system and the host device are in some embodiments configured for bidirectional communications. In various embodiments, the configuration is arranged to facilitate the communications according to a time-division-multiple access (TDMA) channel access method or any of its variants.

Media content and messages from the portable system are sent by a forward channel to the host device, and messages from the host device are sent by a back channel to the portable system. In some implementations, the portable system, host system, and communication channel connecting them are configured to allow simultaneous bidirectional communications.

An instruction from the host device to the portable system can be configured to establish or alter a function or setting at the portable system. The function or setting can be configured to, for instance, affect selection at the portable system of the codec and/or codec parameter(s) to be used in display rendering or replicating the visual media at the host device.

In some embodiments, the portable system includes a human-machine interface (HMI), such as a button, knob, or microphone. The portable system is configured to receive user input by way of the HMI, and trigger any of a variety of actions, including altering a portable system function or setting previously established, establishing a function or setting, and generating a message for sending to the host device containing instructions to alter or establish a function or setting of the host device.

In some embodiments the host system is part of an automobile, or at least configured for implementation as a part of an automobile having the communication port and the display screen device mentioned.

Other aspects of the present invention will be in part apparent and in part pointed out hereinafter.

### DESCRIPTION OF THE DRAWINGS

FIG. 1 illustrates schematically an environment in which the present technology is implemented, including a portable system and a host device.

FIG. 2 illustrates operations of an algorithm programmed at the portable system of FIG. 1.

FIG. 3 illustrates operations of an algorithm programmed at the host device of FIG. 1.

The figures are not necessarily to scale and some features may be exaggerated or minimized, such as to show details of particular components.

In some instances, well-known components, systems, materials or methods have not been described in detail in order to avoid obscuring the present disclosure.

### DETAILED DESCRIPTION

As required, detailed embodiments of the present disclosure are disclosed herein. The disclosed embodiments are merely examples that may be embodied in various and alternative forms, and combinations thereof. As used herein, for example, exemplary, and similar terms, refer expansively to embodiments that serve as an illustration, specimen, model, or pattern.

Specific structural and functional details disclosed herein are not to be interpreted as limiting, but merely as a basis for the claims and as a representative basis for teaching one skilled in the art to employ the present disclosure.

While the present technology is described primarily herein in connection with automobiles, the technology is not limited to automobiles. The concepts can be used in a wide variety of applications, such as in connection with aircraft and marine craft, and non-transportation industries such as with televisions.

Other non-automotive implementations can include plug-in peer-to-peer, or network-attached-storage (NAS) devices.

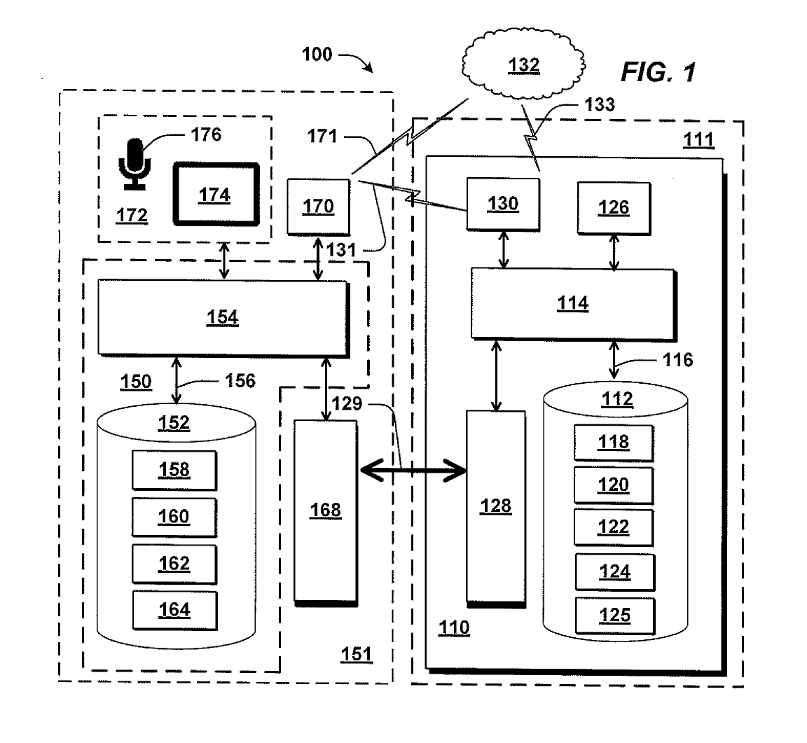

### I. FIG. 1—Technology Environment

FIG. 1 shows an environment 100 in which the present technology is implemented. The environment 100 includes a portable apparatus 110 and a host apparatus 150. For simplicity and not to limit scope, the portable apparatus 110 is referred to primarily herein as a portable system, and the host apparatus 150 as a host device. In one embodiment, the portable system and host device 110, 150 are a consolidated system.

The portable system 110 can take any of a variety of forms, and be referenced in any of a variety of other ways—such as by peripheral device, peripheral system, portable peripheral, peripheral, mobile system, mobile peripheral, portable system, and portable mass-storage system.

The portable system 110 can be referred to as portable based on any of a variety of reasons, such as by being readily attachable/removable to/from the host device, such as by a plug-in arrangement, and/or by being mobile, such as by being wireless and compact for being readily carried about by a user. The portable system 110 can include or be part of another apparatus 111 such as a dongle or a mobile communications device, such as a smart phone.

Although connections are not shown between all of the components of the portable system 110 and the host device 150, the components interact with each other to carry out the functions described herein.

The portable system 110 includes a hardware storage device 112. The hardware storage device 112 can be referred to by other terms, such as a memory, or computer-readable medium, and can include, e.g., volatile medium, non-volatile medium, removable medium, and non-removable medium. The term hardware storage device and variants thereof, as used in the specification and claims, refer to tangible or non-transitory, computer-readable storage devices. The component is referred to primarily herein as a hardware storage device 112.

In some embodiments, storage media 112 includes volatile and/or non-volatile, removable, and/or non-removable media, such as, for example, random access memory (RAM), read-only memory (ROM), electrically erasable programmable read-only memory (EEPROM), solid state memory or other memory technology, CD ROM, DVD, BLU-RAY, or other optical disk storage, magnetic tape, magnetic disk storage or other magnetic storage devices.

The portable system 110 also includes a computer processor 114 connected or connectable to the hardware storage device 112 by way of a communication link 116, such as a computer bus.

The processor 114 can be referred to by other terms, such as processing hardware unit, processing hardware device, processing hardware system, processing unit, processing device, or the like.

The processor 114 could be multiple processors, which could include distributed processors or parallel processors in a single machine or multiple machines. The processor 114 can be used in supporting a virtual processing environment.

The processor 114 can include or be a multicore unit, such as a multicore digital signal processor (DSP) unit or multicore graphics processing unit (GPU).

The processor 114 can be used in supporting a virtual processing environment. The processor 114 could include a state machine, application specific integrated circuit (ASIC), programmable gate array (PGA) including a Field PGA (FPGA), DSP, GPU, or state machine.

The portable system 110 in various embodiments comprises one or more complimenting media codec components, such as a processing or hardware component, and a software component to be used in the processing. The hardware or processing component can be a part of the processing device 114.

References herein to processor executing code or instructions to perform operations, acts, tasks, functions, steps, or the like, could include the processor 114 performing the operations directly and/or facilitating, directing, or cooperating with another device or component to perform the operations.

The hardware storage device 112 includes computer-executable instructions or code 118. The computer-executable code 118 are executable by the processor 114 to cause the processor 114, and thus the portable system 110, to perform any combination of the functions described herein regarding the portable system.

The hardware storage device 112 in various embodiments includes other code or data structures, such as a file sub-system 120, a framebuffer capture component 122, and a media codec component 124.

As mentioned, the portable system 110 in various embodiments comprises one or more complimenting media codec components, such as a processing, or hardware component, and a software component to be used in the processing. The software media codec component is indicated by reference numeral 124.

A framebuffer of display screen can be a transferred video source, such as in the form of a data content package, captured by the framebuffer capture component 122.

The device 112 in various embodiments stores at least some of the data received and/or generated, and to be used in processing, in a file-based arrangement corresponding to the code stored therein. For instance, when an FPGA is used, the hardware storage device 112 can include configuration files configured for processing by the FPGA.

Any of the hardware storage device 112 components may be combined, separated, or removed. References herein to portable-system operations performed in response to execution of any memory 112 component can be performed by execution of another, or a combined or separated, memory 112 component. For instance, if the first illustrated code 118 is described as being configured to cause the processor 114 to perform a certain operation, the instructions of another memory 112 component can be configured to cause the processor 114 to perform the operation.

The file sub-system 120 can include a first level cache and in some implementations also a second level cache.

In some embodiments, the hardware storage device 112 includes code of a dynamic programming language 125, such as JavaScript, Java or a C/C++ programming language. The host device 150 includes the same programming language, which is indicated in FIG. 1 by reference numeral 164. The component 164 of the host device 150 in some implementations includes an application framework, such as the media application mentioned and/or an application manager for managing operations of the media application at the host device 150.

The programming language code can define settings for communications between the portable system 110 and the host device 150, such as features of one or more application program interfaces (APIs) by which the portable system 110 and device 150 communicate.

The portable system 110 in some embodiments includes at least one human-machine interface (HMI) component 126. For implementations in which the interface component 126 facilitates user input to the processor 114 and output from the processor 114 to the user, the interface component 126 can be referred to as an input/output (I/O) component.

As examples, the interface component 126 can include, or be connected to, a sensor configured in any of a variety of ways to receive user input. In various implementations the interface component 126 includes at least one sensor configured to detect user input provided by, for instance, a touch, an audible sound or a non-touch motion or gesture.

A touch-sensor interface component can include a mechanical actuator, for translating mechanical motion of a moving part such as a mechanical knob or button, to an electrical or digital signal. The touch sensor can also include a touch-sensitive pad or screen, such as a surface-capacitance sensor.

For detecting gestures, the interface component 126 can include or use a projected-capacitance sensor, an infrared laser sub-system, a radar sub-system, or a camera sub-system, by way of examples.

The interface component 126 is connected to the processor 114 for passing user input received as corresponding signals or messages to the processor.

In various implementations the interface component 126 includes or is connected to a visual or audible indicator such as a light, digital display, or tone generator, for communicating output to the user.

The interface component 126 can be used to affect functions and settings of one or both of the portable system 110 and the host device 150 based on user input. Signals or messages corresponding to inputs received by the interface component 126 are transferred to the processor 114, which, executing code (e.g., code 118) of the hardware storage device 112, sets or alters a function at the portable system 110. Inputs received can also trigger generation of a communication, such as an instruction or message, for the host device 150, and sending the communication to the host device 150 for setting or altering a function or setting of the host device 150.

The portable system 110 is in some embodiments configured to connect to the host device 150 by a hard, or wired connection 129. The connection is referred to primarily herein as a wired connection in a non-limiting sense. The connection can include components connecting wires, such as the USB plug-and-port arrangement described, or wireless component such as wireless USB.

In some other embodiments, the connection is configured with connections according to higher throughput arrangements, such as using an HDMI port or a VGA port.

The portable system 110 can, as mentioned, be configured as a dongle, such as by having a data-communications plug 128 for connecting to a matching data-communications port 168 of the host device 150. An example data-communications plug 128 is a USB plug, for connecting to a USB port of the host device 150.

In these ways, advanced functions are available by way of relatively low-rate connection, such as USB device class components, whereas they would not otherwise be. And if a higher- or high-capability class device is available (e.g., if the vehicle is already configured with or for such device class), the system can be configured to directly use the higher-capability class device to provide the advanced functions.

For instance, while the portable system 110 is in some embodiments a portable mass-storage device, more advanced USB device classes such as Media Transfer Protocol (MTP) could be supported.

The portable system 110 is configured in various embodiments to operate any one or more of a variety of types of computer instructions that it may be programmed with for dynamic operations and/or that it may receive for dynamic processing at the system 110

In some embodiments, the portable system 110 is configured for wireless communications with the host device 150 and/or another system 132 external to the portable system 110, such as a remote network or database. By numeral 130 in FIG. 1, a wireless input or input/output (I/O) device—e.g., transceiver—or simply a transmitter, is referenced. Wireless communications with the host device 150 and external system 132 are referenced by numerals 131, 133, respectively.

The wireless device 130 can in various embodiments communicate with any of a wide variety of networks, including cellular communication networks, satellite networks, and local networks such as by way of a roadside-infrastructure or other local wireless transceiver, beacon, or hotspot. The wireless device 130 can also communicate with near-field communication (NFC) devices to support functions such as mobile payment processing, or communication setup/handover functions, or any other use cases that are enabled by NFC. The wireless device 130 can include for example, a radio modem for communication with cellular communication networks.

The remote system 132 thus in various embodiments includes any of cellular communication networks, road-side infrastructure or other local networks, for reaching destinations such as the Internet and remote servers. The remote system 132 may be a server, and may be a part of, or operated by, a customer-service center or system, such as the OnStar® system (ONSTAR is a registered trademark of Onstar LLC of Detroit, Mich.).

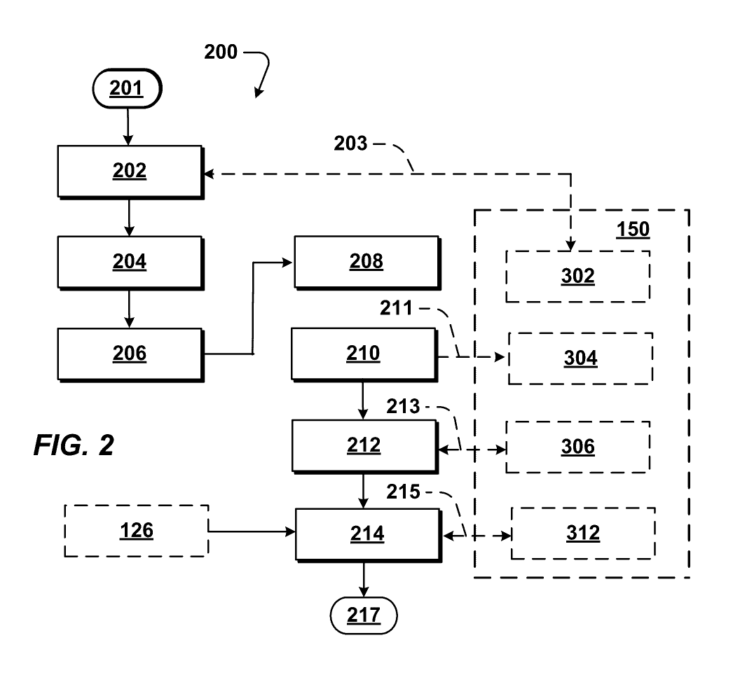

Other features of the portable system 110 are described below, primarily in connection with the algorithm of FIG. 2.

The host device 150 is, in some embodiments, part of a greater system 151, such as an automobile.

As shown, the host device 150 includes a memory, or computer-readable medium 152, such as volatile medium, non-volatile medium, removable medium, and non-removable medium. The term computer-readable media and variants thereof, as used in the specification and claims, refer to tangible or non-transitory, computer-readable storage devices. The component is referred to primarily herein as a storage device 152.

In some embodiments, storage media includes volatile and/or non-volatile, removable, and/or non-removable media, such as, for example, random access memory (RAM), read-only memory (ROM), electrically erasable programmable read-only memory (EEPROM), solid state memory or other memory technology, CD ROM, DVD, BLU-RAY, or other optical disk storage, magnetic tape, magnetic disk storage or other magnetic storage devices.

The host device 150 also includes an embedded computer processor 154 connected or connectable to the storage device 152 by way of a communication link 156, such as a computer bus.

The processor could be multiple processors, which could include distributed processors or parallel processors in a single machine or multiple machines. The processor can be used in supporting a virtual processing environment. The processor could include a state machine, application specific integrated circuit (ASIC), programmable gate array (PGA) including a Field PGA, or state machine. References herein to processor executing code or instructions to perform operations, acts, tasks, functions, steps, or the like, could include the processor 154 performing the operations directly and/or facilitating, directing, or cooperating with another device or component to perform the operations.

The device 152 in various embodiments stores at least some of the data received and/or generated, and to be used in processing, in a file-based arrangement corresponding to the code stored therein. For instance, when an FPGA is used, the hardware storage device 152 can include configuration files configured for processing by the FPGA.

The storage device 152 includes computer-executable instructions, or code 158. The computer-executable code 158 is executable by the processor 154 to cause the processor, and thus the host device 150, to perform any combination of the functions described in the present disclosure regarding the host device 150.

The host device 150 includes other code or data structures, such as a file sub-system 160, a dynamic-programming-language (e.g., JavaScript, Java or a C/C++ programming language), and an application framework 162. Any of these memory 152 components may be combined, separated, or removed. References herein to host system operations performed in response to execution of any memory 152 component can be performed by execution of another, or a combined or separated, memory 152 component. For instance, if the first illustrated code 158 is described as being configured to cause the processor 154 to perform a certain operation, the instructions of another memory 152 component can be configured to cause the processor 154 to perform the operation.

The file sub-system 160 can include a first level cache and a second level cache. The file sub-system 160 can be used to store media, such as video or image files, before the processor 154 publishes the file(s).

The dynamic-programming-language (e.g., JavaScript, Java or a C/C++ programming language) application framework 162 can be part of the second level cache. The dynamic-programming-language is used to process media data, such as image or video data, received from the portable system 110. The programming language code can define settings for communications between the portable system 110 and the host device 150, such as characteristics of one or more APIs.

The host device 150 includes or is in communication with one or more interface components 172, such as an HMI component. For implementations in which the components 172 facilitate user input to the processor 154 and output from the processor 154 to the user, the components can be referred to as input/output (I/O) components.

For output, the interface components can include a visual-output or display component 174, such as a screen, and an audio output such as a speaker. In a contemplated embodiment, the interface components 172 include components for providing tactile output, such as a vibration to be sensed by a user, such as by way of a steering wheel or vehicle seat to be sensed by an automobile driver.

The interface components 172 are configured in any of a variety of ways to receive user input. The interface components 172 can include for input to the host device 150, for instance, a mechanical or electro-mechanical sensor device such as a touch-sensitive display, which can be referenced by numeral 174, and/or an audio device 176 such as an audio sensor—e.g., microphone—or audio output such as a speaker. In various implementations, the interface components 172 includes at least one sensor. The sensor is configured to detect user input provided by, for instance, touch, audibly, and/or by user non-touch motion, such as by gesture.

A touch-sensor interface component can include a mechanical actuator, for translating mechanical motion of a moving part such as a mechanical button, to an electrical or digital signal. The touch sensor can also include a touch-sensitive pad or screen, such as a surface-capacitance sensor. For detecting gestures, an interface component 172 can use a projected-capacitance sensor, an infrared laser sub-system, a radar sub-system, or a camera sub-system, for example.

The interface component 172 can be used to receive user input for affecting functions and settings of one or both of the portable system 110 and the host device 150. Signals or messages corresponding to inputs are generated at the component 172 and passed to the processor 154, which, executing code of the storage device 152, sets or alters a function or setting at the host device 150, or generates a communication for the portable system 110, such as an instruction or message, and sends the communication to the portable system 110 for setting or altering a function or setting of the portable system 110.

The host device 150 is in some embodiments configured to connect to the portable system 110 by wired connection 129. The host device 150 is in a particular embodiment configured with or connected to a data-communications port 168 matching the data-communications plug 128 of the portable system 110. An example plug/port arrangement provided is the USB arrangement mentioned. Another example could be wireless USB protocol.

In some embodiments, the host device 150 is configured for wireless communications 131 with the portable system 110. A wireless input, or input/output (I/O) device—e.g., transceiver—of the host device 150 is referenced by numeral 170 in FIG. 1. The processor 154, executing code of the storage device 152, can wirelessly send and receive information, such as messages or packetized data, to and from the portable system 110 and the remote system 132 by way of the wireless device 170 as indicated by numerals 131, 171, respectively.

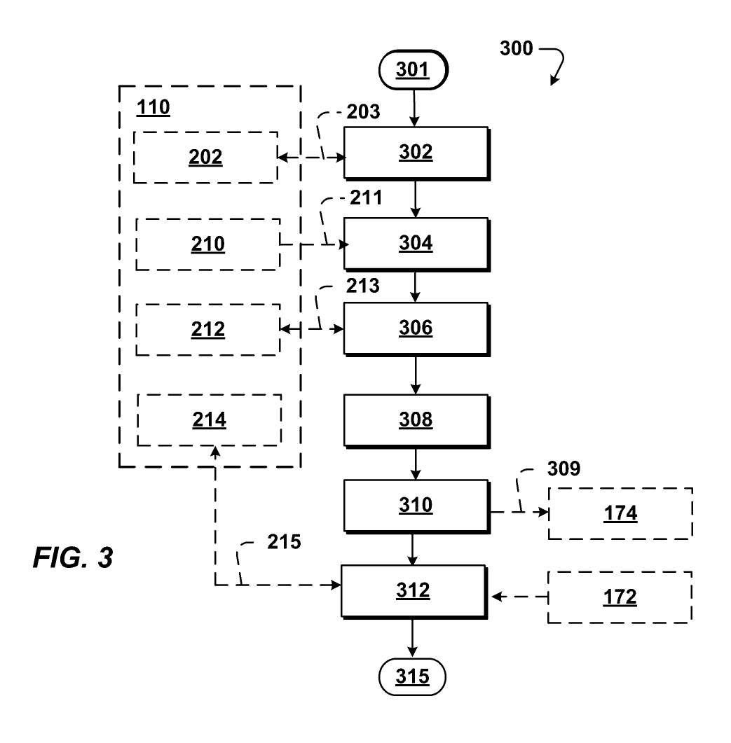

Other features and functions of the host device 150 are described below, primarily in connection with the algorithm of FIG. 3.

### II. FIGS. 2 and 3—Algorithms and Functions

The algorithms by which the present technology is implemented are now described in more detail. The algorithms are outlined by flow charts arranged as methods 200, 300 in FIGS. 2 and 3.

FIG. 2 illustrates operations of an algorithm programmed at the portable system 110 of FIG. 1. FIG. 3 illustrates operations of an algorithm programmed at the host device 150.

In one implementation, the algorithm is configured to determine a preferred, or applicable codec family and/or codec parameter for use in processing media (e.g., video) based on a subject application being used to present the media. The corresponding methods can be referred to as closed-loop because they do not require analyzation of other data, such as real-time characteristics of the media being transferred and display rendered or replicated.

In another, open-loop implementation, the portable system 110 analyzes the media and selects a codec family and/or codec parameter based on characteristics of the media. The analysis in some implementations is real-time, being performed as part of the process of transferring the media to the host device 150 and display rendering there. Example visual characteristics include sharpness and concentration, and are not limited to these two characteristics. Analyzing concentration can including generating or at least analyzing a historic, or histogram, concentration.

In one embodiment, the portable system 110 is configured to facilitate either the closed loop process or the open loop process selectively. The analysis can be used to determine a type of screen frames being processed, such as more text-centric-type screen frames or more image/video-centric-type screen frames.

As an example sharpness (SH) metric calculation, any of the following relationships can be used:

$$\begin{matrix}image ( x , y ) {\to }^{FFT} M ( φ ) {\to }^{Filter} \begin{matrix}{M}_{H} ( φ ) \\ {M}_{L} ( φ )\end{matrix} & Relationship [ 1 ] \\ {SH}_{Frame \_ X} = \frac{{\int }_{φ ∈ H} M ( φ ) d φ}{{\int }_{φ ∈ L} M ( φ ) d φ + {\int }_{φ ∈ H} M ( φ ) d φ} & Relationship [ 2 ]\end{matrix}$$

Regarding the histogram concentration (HC), any of the following relationships can be used:

$$\begin{matrix}image ( x , y ) {\to }^{Graylization} G ( x , y ) {\to }^{Histogram} & Relationship [ 3 ] \\ {HC}_{Frame \_ X} = 1 - \frac{n}{N} & Relationship [ 4 ]\end{matrix}$$

wherein n is a number of Concentration Peak and N is a number of Overall Gray Levels, for instance.

For processing the sharpness (SH) metric and histogram concentration (HC) metric to obtain an appropriate codec or codec family (C), the following relationship can be used:

$$\begin{matrix}{C}_{Frame \_ X} = f ( {SH}_{x} , {HC}_{x} ) \\ = α {SH}_{x} + ( 1 - α ) {HC}_{x}\end{matrix} \qquad Relationship [ 6 ]$$

The sharpness (SH) and histogram concentration (HC) metrics can be used in determining a codec or codec family (C) in a variety of ways without departing from the scope of the present technology. As a general example, the concentration (C) can be low if the sharpness (SH) is low (e.g., ≦0.4) and the histogram concentration (HC) is low; and the concentration (C) can be high if the sharpness (SH) is high (e.g., >0.4) and the histogram concentration (HC) is high. These general relationships can be shown by simple chart form as follows:

| SH | HC | C |
|---|---|---|
| Low | Low | Low |
| High | High | High |

In a contemplated, hybrid, embodiment, the open and closed loops are both used to some degree. In another contemplated embodiment, the portable system 110 is configured to determine which process, open-loop or closed-loop, to use for a particular piece of media. The determination can be based on characteristics of the media, such as sharpness and concentration of video being processed and/or the determination can be based on an identify or a category of an application being used to obtain the video, by way of examples.

It should be understood that operations of the methods 200, 300 are not necessarily presented in a particular order and that performance of some or all the operations in an alternative order is possible and contemplated.

The operations have been presented in the demonstrated order for ease of description and illustration. Operations can be added, omitted and/or performed simultaneously without departing from the scope of the appended claims.

It should also be understood that the illustrated algorithms 200, 300 can be ended at any time. In certain embodiments, some or all operations of this process, and/or substantially equivalent operations are performed by execution by the processors 114, 154 of computer-executable code of the storage devices 112, 152 provided herein.

### II.A. Portable System Operations—FIG. 2

The algorithm 200 of FIG. 2 is described primarily from the perspective of the portable system 110 of FIG. 1.

The algorithm 200 commences 201 and flow proceeds to a first-illustrated operation 202 whereat the portable system 110 is placed in communication with the host device 150. Corresponding activity of the host device 150 for this interaction 202 is described further below in connection with FIG. 3, and particularly block 302 of FIG. 3.

The operation 202 establishes a channel by which data and communications such as messages or instructions can be shared between the portable system 110 and the host device 150.

Connecting with the host device 150 can include connecting by wire 129 (e.g., plug to port) or wirelessly 131, both being represented schematically by numeral 203 in FIG. 2.

Example host devices 150 include a head unit, or an on-board computer, of a transportation vehicle such as an automobile.

The portable system 110 is in a particular embodiment configured as a dongle, such as by having a data-communications plug 128—e.g., USB plug—for connecting to a matching port 168 of the host device 150. For communications between the portable system 110 and the host device 150, each can include in their respective storage devices 112, 512, a protocol operable with the type of connection. With the USB plug/port example, the protocol can be a USB mass-storage-device-class (MSC) computing protocol. Other, e.g., more advanced, USB protocols, including Media Transfer Protocol (MTP), could also be supported.

The portable system 110 is in some embodiments configured to connect to the host device 150 by wireless connection, referenced by numeral 131 in FIG. 1, and also by numeral 203 in FIG. 2.

The portable system 110 connected communicatively with the host device 150 in some embodiments performs a handshake process with the host device 150. The handshake process can also be considered indicted by reference numeral 203 in FIG. 2.

For embodiments in which both devices include a dynamic programming language, such as JavaScript, Java or a C/C++ programming language, the operation 202 can include a handshake or other interfacing routine between the portable system 110 and the host device 150 using the dynamic programming language.

Flow of the algorithm 200 proceeds to block 204 whereat the processor 114 receives, such as by way of the wireless communication component 130, source media, such as streaming video—e.g., a video file—from a source, such as a remote source 132, or virtual video source such as a framebuffer, or virtual video file, linked to the framebuffer associated in the system—e.g., system memory—with the display screen for rendering media received from a remote device. The remote source can include a server of a customer-service center or system, such as a server of the OnStar® system.

In various embodiments, the source media file referenced is a virtual file, such as in the form of a link or a pointer linked to a memory location containing particular corresponding media files, or a particular subset of the media files.

While the present technology processes data having a file format, the result is a novel manner of streaming video and audio. The data being processed at any time includes a volume of still images. The still-image arrangement involving the volume (e.g., thousands) of still images, facilitates delivery of high-speed streaming video, with low latency, including by flushing the cache in the implementation of a plug-in mass-storage system such as those using the USB mass storage class (USB MSC) protocol.

While the technology can be used to transfer and display render or replicate in real time—e.g., render for displaying or display purposes—various types of media files, including those with or without video, and with or without audio, the type of file described primarily herein is a video file representing a graphic output, or data for being output as a corresponding graphical display at a display screen, which in various embodiments does or does not include audio.

References in the present disclosure to streaming video or video files should for various embodiments be considered to include any of the media file types possible.

The operation 204 can include receiving the streaming video in one piece, or separate portions simultaneously or over time.

In a contemplated embodiment, the video file is received from a local source, such as a virtual video file linked to the framebuffer associated in the system—e.g., system memory—with the display screen. In embodiments, a primary, if not sole, video source is the framebuffer.

The local source can include, for instance, a smart phone or other mobile device that either receives the streaming video from a remote source and passes it on to the portable system 110, or has the video stored at the local source. The transfer from the local source to the portable system 110 can be by wire or made wirelessly.

For embodiments in which a subject media, or multimedia, application is present at the portable system 110, receiving the media file(s) can include receiving them using the application.

In various embodiments the streaming video has any of a variety of formats, such as .mpeg, .wmv, or .avi formats, just by way of example.

Flow proceeds to block 206 whereat the processor 114 determines an application characteristic. The application characteristic includes in various embodiments one or both of an application identity and an application category associated with a subject application.

Versions of the subject application can be running at the portable system 110 and/or at the host device 150. The application can be a media or multimedia application, such as a video application serviced by a remote video application server.

An identity of the application can be indicated in any of a variety of ways. As examples, the application can be identified by application name, code, number, or other indicator.

As provided, an application category is in some implementations the application characteristic used in operation 206. Example application categories include live-video-performance, stored-video, video game, text/reader, animation, navigation, traffic, weather, and any category corresponding to one or more infotainment functions.

In a contemplated embodiment, distinct categories include applications of a same or similar type or genre based on characteristics distinguishing the applications. For instance, a first weather application could be associated with a first category based on its characteristics while a second weather application is associated with another category based on its characteristic. To illustrate, below is a list of six (6) example categories. The phrasing heavy, medium, and light indicate relative amounts of the format of media (e.g., moving map, video, or text) that is expected from, e.g., historically provided by, applications.
1. Heavy moving map/heavy imaging/light video/light text (e.g., some weather apps)
2. Light moving map/medium imaging/light video/heavy text (e.g., some other weather apps)
3. Heavy moving map/medium text (e.g., some navigation apps)
4. Medium moving map/high text (e.g., some other navigation apps)
5. Light text/heavy imaging and/or video (e.g., some e-reading apps, such as children's-reading or visual education e-reading applications)
6. Heavy text/light imaging (e.g., some other e-reading apps).

The application characteristic (e.g., application identity or category) can be obtained in any of a variety of ways. The characteristic is in various embodiments predetermined and stored at the hardware storage device 112 of the portable system 110 or predetermined and stored at the storage device 152 of the host device 150. In one embodiment, the characteristic is indicated in one or more files. The file can contain a lookup table, mapping each of various applications (e.g., a navigation application) to a corresponding application characteristic(s). The file can be stored at the storage device 152 of the host device 150, or at another system, such as a remote server, which can be referenced by numeral 132 in FIG. 1.

In a contemplated embodiment, an application category relates to a property or type of the subject application. In a contemplated embodiment, the application category is determined in real time based on activities of the application instead of by receiving or retrieving an indicator of the category. The processor 114 can determine the application category to be weather, or traffic, for instance, upon determining that the visual media being provided is a moving map overlaid with weather or traffic, respectively.

In a contemplated embodiment, determining the category includes creating a new category or newly associating the application with an existing application. While the application may not have been pre-associated with a category, the processor 114 may determine that the application has a particular property or type lending itself to association with an existing category. In a particular contemplated embodiment, the instructions 118 are configured to cause the processor 114 to establish a new category to be associated with an application that is determined to not be associated with an existing category. In one embodiment, a default category exists or is established to accommodate such applications not matching another category.

At block 208, the processor 114 determines, based on the application characteristic, which of multiple available codec families and/or media system properties or parameters the host device 150 should use to process the visual content.

Codec families are referred to below simply as codecs, and the media system properties or parameters as codec parameters.

In one embodiment, the present technology includes generating mapping data. The mapping process can be performed at the portable system 110, at a remote system 132, or at the host device 150. The mapping process involves determining associations between codec family options and application identities or categories, and storing the associations, such as in the form of a look-up table. A system that has determined an identity or category of an application (e.g., system 110, 132, 150), can consult the mapping data to determine the assigned codec family.

Mapping data can similarly be generated in connection with codec parameters, and mapping data can include associations between an application characteristic (e.g., application identity or application category) and codec parameters.

In some embodiments, identification of the codec and/or the codec parameter options comprises retrieving them from a source outside of the portable system 110, such as the host device 150, or a remote source 132, such as a remote server or database.

In one aspect of the present technology, multiple available codecs and/or codec parameters that a host device should use to process the visual content are determined based on visual properties—e.g., characteristics of subject images or video. Benefits of selecting the codecs and/or codec parameter(s) based on an identify or category of the subject application, versus, for example, selecting the codecs and/or codec parameters based on visual properties of the media being transferred and display rendered in real time, in some cases include a lower requirement for processing resources and a faster processing time to determine the preferred or applicable codec and/or parameter(s).

The codecs and codec parameters can be obtained in any of a variety of ways. As mentioned, codecs and/or the codec parameters are in various embodiments predetermined and stored at the hardware storage device 112 of the portable system 110 or predetermined and stored at the storage device 152 of the host device 150. In one embodiment, the codecs and/or the codec parameters are identified in one or more files, such as a file containing a lookup table, mapping each of various application characteristics to an associated one or more codecs and/or codec parameters to its corresponding application characteristic(s)—e.g., identifier and/or category. The mapping file can be stored at the storage device 152 of the host device 150, or at another system, such as a remote server, which can be referenced by numeral 132 in FIG. 1.

In one embodiment, the processor 114 at operation 208 retrieves operational codecs and/or optional codec parameters available for selection, such as by requesting and receiving one or more lists from the host device 150. The processor 114 then selects amongst the options received.

Example codecs include lossless and lossy codecs. In various contemplated embodiment, more than one different type or level of lossy codec is available.

Generally, lossy codecs are configured to allow some loss of some of the details of the subject media—e.g., video—being processed. Processing by lossy codec thus results in inexact approximations representing the original content. Results of using lossy codecs include reducing an amount of data that would otherwise be needed to store, handle, and/or transmit the represented content. Some lossy codecs allow reduction of visual content data with no, or very little, perceivable image degradation to the casual viewer.

To the contrary, lossless codecs are configured to allow original data to be perfectly, or nearly perfectly, reconstructed in processing after being transferred. An example lossless format or compression is RFB/VNC.

Benefits of such lossless formats include an ability to transfer all or substantially of the media, such as video, for rendering without blur effects or other diminished visual characteristics, and this without careful management by the processing device. Avoiding blur or other diminished visual characteristics is important for viewing media in which details are important to enjoyment or comprehension. An example is text-based pages that can be rendered unclear or difficult to read by blurring.

Example lossy formats or compressions include H.264, JPEG, and M-JPEG. The format can include HEVC. Benefits of using a lossy compression include an ability to transfer and display render timely high-quality image video, and graphics data.

A look-up file or code relating one or more application identities or application categories to each of multiple codecs is configured based on the type of media—e.g., video or images—expected to be received from the application, or applications of the category.

In some implementations, the look-up file or code relating one or more application category or identity to a codec is configured so that applications providing visual media that is less visual-details-critical are associated with a lossy codec. For instance, in video, although motion is usually visible on the screen, such as person walking across a field of grass in the video, much of the time, much of the imaging shown does not change much and/or there is not a high value on display rendering all of the imaging in high detail. Further with the example of the person walking in the field, some level of lossy code could be used considering that the field is not changing much over time, and considering that the value of providing high visual detail of the grass in the field is not very high. In other words, the overall user viewing experience or comprehension is not diminished much, if at all, if some of the detail is removed in processing using a lossy codec.

The look-up file or code can be configured so that applications providing visual media such as text or map-based navigation information are associated with a lossless codec, or at least a less lossy codec. The rationale is that discarding details of such types of media are more likely to be noticed by a viewer, lowering viewer experience, making comprehension uncomfortable or difficult.

For embodiments in which multiple lossy codes are available, the more media of a subject application tends to provide a certain type of media, such as video versus text, the more lossy the codec associated with the application identified or subject application category. An application that provides at various times various forms of media, e.g., video, maps, and text, such as a weather or news app, can be associated, by its identity or category, with a level of lossy codec according to respective levels of these various types of media that the application provides historically.

As an example of application category/codec mapping, an application determined associated with a navigation category can be associated in a look-up file or code, wherever stored (e.g., memory 112, 152, or remote 132), with a lossless codec. As another example application category/codec mapping, the look-up file or code may be configured to map the codec/category to a lossy codec if the application is determined associated with a video category.

Example codecs parameters include any of a variety of compression ratios. As another example, the codecs parameters can include any of a variety of resolution levels.

If a subject application is determined associated with a navigation category, as an example, the system 110 may determine, based on the application characteristic, that a relatively high resolution (such as 1280×800 pixels and/or a compression ratio of 0.5) should be used in processing the corresponding visual navigation media from the application. It should be understood that these parameter values are purely exemplary.

As another example, if an application is determined associated with a video category, the system 110 may determine, based on the application characteristic, that a lower resolution, such as 800×480 pixels and/or a lower compression ratio, such as 0.2, should be used in processing the corresponding video media from the application. Again, these parameter values are purely exemplary.

As mentioned, the portable system 110 in some embodiments has, in the hardware storage device 112, code of a dynamic programming language 125, such as JavaScript, Java or a C/C++ programming language. The language can be used in system 110 operations including image processing operations such as the function of selecting a preferred or appropriate codec and/or codec parameters to use under the circumstances.

With continued reference to FIG. 2, at block 210, the processor 114 sends to the host device 150 a communication indicating the codec and/or codec parameter(s) determined, for use in processing the media—e.g., visual content. The transfer is referenced by numeral 211. Corresponding activity of the host device 150 is described further below in connection with FIG. 3, and particularly at block 304 there.

At block 212, the processor 114 sends the media content to the host device 150 for display rendering at the host device 150 using the codec and/or the codec parameters(s) determined. The transfer is referenced by numeral 213. Corresponding activity of the host device 150 is described further below in connection with FIG. 3, and particularly at block 306 there.

At block 214, the processor 114 generates, identifies , retrieves, receives, or otherwise obtains instructions or messages configured to change or establish a setting or function. For instructions for adjusting a setting or function of the portable system 110, the processor 114 executes the instruction. For instructions for adjusting a setting or function of the host device 150, the processor 114 generates the communication and sends 215 it to the host device 150. Both communication channels are indicated by a double-arrowed line labeled 215 in FIG. 2. Corresponding activity of the host device 150 is indicated by numeral 312.

The function can be or relate to one or more portably-system functions affecting the operation of determining which of multiple available codecs to use to process the visual content.

In various embodiments, the operation 214 involves receiving at the processor 114 a signal or message from the HMI interface component 126. The interface component 126 can include, for instance, a sensor configured to detect user input provided by a touch, sound, or a non-touch motion or gesture. The interface 126 can include a button, knob, or microphone, for instance, by which the user can provide input to the portable system 110 for affecting or establishing settings or functions of the portable system 110 and/or the host device 150.

As mentioned, the portable system 110 and the host device 150 are configured for bidirectional communications between them. The configuration in some cases allows simultaneous bidirectional communications between them. As also provided, in various embodiments, the configuration is arranged to facilitate the communications according to the TDMA channel-access method.

A forward channel, from the portable system 110 to the host device 150, carries the codec and/or codec parameter selected 210, the subject media (e.g., video or image files), and any instructions or messages configured to affect functions or settings of the host device 150. A back channel would carry from the host device 150 to the portable system 110 any instructions or messages configured to alter or establish a function or setting of the portable system 110.

The process 200 can end 217 or any portions thereof can be repeated, such as in connection with a new file associated with a new video, or with subsequent portions of the same video.

In various embodiments, the portable system 110 can be personalized or customized, such as by settings or user preferences. These can be programmed to the portable system 110 by any of a variety of methods, including by way of the host device 150, a personal computer (now shown), a mobile phone, or the like. In some embodiments, default settings or preferences are provided before any personalization is performed. The settings or functions to be personalized can include any of those described herein, such as a manner by which incoming video is processed, or playback qualities at the host device 150 such as rewind, fast-forward. The manner by which incoming video is processed can include, for instance, a manner by which codecs or codec parameters are selected. The manner by which codecs or codec parameters are selected can affect other processes, such as by making bandwidth available for a VOIP call.

### II.B. Host Device Operations—FIG. 3

The algorithm 300 of FIG. 3 is described primarily from the perspective of the host device 150 of FIG. 1. As provided, the host device 150 can include or be a part of a head unit, or on-board computer, of a transportation vehicle, such as an automobile, for example.

The algorithm 300 begins 301 and flow proceeds to the first operation 302 whereat the host device 150 is placed in communication with the portable system 110. Connecting with the host device 150 can include connecting by wired or wireless connection 129, 131.

The connection of block 302 can include a handshake process between the host device 150 and the portable system 110, which can also be considered indicted by reference numeral 203 in FIGS. 2 and 3. The process at operation 302 establishes a channel by which data and communications such as messages or instructions, can be shared between the portable system 110 and the host device 150.

For embodiments in which both devices include a dynamic programming language, such as JavaScript, Java or a C/C++ programming language, the operation 302 can include a handshake routine between the portable system 110 and the host device 150 using the dynamic programming language.

Flow proceeds to block 304 whereat the processor 154 receives, from the portable system 110, the codec and/or codec parameter determined at the portable system 110. The transmission is referenced by numeral 211 in connection with associated operation 210 of the portable system 110.

At block 306, the processor 154 receives the media file from the portable system 110. The transmission is referenced by numeral 213 in connection with associated operation 212 of the portable system 110.

Flow proceeds to block 308 whereat the processor 154 processes the media file received using the codec and/or codec parameters received.

The media file can take any of a variety of forms, such as in the form of a streaming video (e.g., .mpeg) or in the form of image snippets (e.g., jpegs) constituting the video. In one embodiment, for instance, the portable system 110 is configured to divide an incoming video into a plurality of indexed (e.g., consecutively-ordered) image components, and at block 212 send the image components corresponding to the video to the host device 150 for display rendering of the images as video using the code and/or codec parameter(s) received.

As mentioned, the host device 150 in some embodiments has stored in its storage device 152 code of a dynamic programming language 164, such as JavaScript, Java or a C/C++ programming language. The language in some implementations includes an application framework for facilitating image processing functions of the host device 150. The programming language code can define settings for communications between the portable system 110 and the host device 150, such as parameters of one or more APIs, and/or the manner by which the media files (e.g., video or image files) are processed using the codec and/or codec parameters.

Flow proceeds to block 310 whereat the resulting video is transferred, by wire or wirelessly, to a visual-display component 174. An example visual component is an infotainment screen of a greater system 151 such as an automobile. The transfer is indicated by numeral 309 in FIG. 3.

At block 312, the host device 150 generates, identifies, retrieves, receives, or otherwise obtains instructions or messages, such as orders or requests for changing of a setting or function. Regarding instructions for adjusting a setting or function of the host device 150, the processor 154 executes the instruction. Regarding instructions for adjusting a setting or function of the portable system 110, the processor 154 sends the instruction or message to the portable system 110. Both communication channels are indicated by the double-arrowed line labeled 215 in FIG. 3. Corresponding activity of the portable system is indicated by numeral 214.

Generation of communications 215 from the host device 150 to the portable system 110 can be triggered by user input to an input component 172 of the host device 150. The input can include touch input to a touch-sensitive screen 174, for example, or audio input to a vehicle microphone 176.

In various embodiments, the host device 150 (e.g., code 158 thereof) is configured to enable generation of messages or instructions for personalizing, or customizing, the portable system 110, such as by being configured to establish or adjust a function or setting of the portable system 110 as requested by a user input to the host device 150. Settings or functions of the portable system 110 can also be established or adjusted by other ways, such as by way of a personal computer (now shown), a mobile phone, or the like. The settings or functions of the portable system 110 to be personalized can include any of those described herein, such as a manner by which incoming video is processed at the portable system 110.

The process 300 or portions thereof can be repeated, such as in connection with a new video or media, or with subsequent portions of the same video.

### III. Select Benefits of the Present Technology

Many of the benefits and advantages of the present technology are described above. The present section restates some of those and references some others. The benefits are provided by way of example and are not exhaustive of the benefits of the present technology.

The technology allows transfer and real-time display rendering or replicating of video data in an efficient and effective manner from a portable system to a host device such as an automobile head unit.

The systems and algorithms described can be used to transfer and display render or replicate in real time high-speed video streams by way of a relatively low-transfer-rate connection, such as a USB connection. In this way, advanced functions are available by way of relatively low-capability USB-device-class components, whereas they would not otherwise be. And if a higher- or high-capability class device is available (e.g., if the vehicle is already configured with or for such device class), the system can be configured to directly use the higher-capability class device to provide the advanced functions.

The portable system facilitates efficient and effective streaming of video or other visual media data at an existing host device, such as a legacy automotive on-board computer in a used, on-the-road vehicle. Legacy systems have limited processing power and software and/or hardware capacity as compared to some very-modern and next-generation systems. The present technology allows presentation of video from a remote source to a user by way of such legacy systems, and with a quality and timing comparable to the very-modern and next-generation systems.

Benefits of using lossless compressions include their ability to transfer all or substantially of subject media, such as video, for rendering without blur effects or other diminished visual characteristics, and this without careful management at the processing device. Benefits of using a lossy compression include the ability to transfer and display render timely—e.g., real time—high-quality visual media, such as video and graphics data.

The processes for transfer and real-time display rendering or replicating of video data can also affect other local processes, such as by making bandwidth available for a VOIP call at a host vehicle.

As another benefit, the capabilities described herein can be provided using a convenient portable system. The portable system can be manufactured mostly or entirely with parts that are readily available and of relatively low cost.

### IV. Conclusion

Various embodiments of the present disclosure are disclosed herein. The disclosed embodiments are merely examples that may be embodied in various and alternative forms, and combinations thereof.

The above-described embodiments are merely exemplary illustrations of implementations set forth for a clear understanding of the principles of the disclosure. Variations, modifications, and combinations may be made to the above-described embodiments without departing from the scope of the claims. All such variations, modifications, and combinations are included herein by the scope of this disclosure and the following claims.

What is claimed is:

1. A portable system comprising:
a processor; and
a non-transitory storage device comprising and computer-executable code that, when executed by the processor, causes the processor to perform operations comprising:
receiving, from a source, a media file comprising visual content;
determining an application characteristic selected from a group consisting of an application identity and an application category associated with an application to be used in delivering the visual content;
determining, based on the application characteristic, which of multiple available codecs the host device should use to process the visual content;
sending, to the host device, a communication indicating the codec for use in processing the visual content; and
sending the visual content to the host device for display rendering using the codec determined.

2. The portable system of claim 1 wherein the operations further comprise:
determining, based on the application characteristic, which of multiple available codec parameters to use in processing the visual content; and
sending, to the host device, a communication indicating the codec parameter to be used in processing the visual content.

3. The portable system of claim 2 wherein the computer-executable code comprises mapping data relating each application characteristic to at least one of the available codecs and to at least one of the available codec parameters, for use in determining the codec and codec parameters.

4. The portable system of claim 2 wherein the available codec parameters comprise various compression ratios and various resolution levels.

5. The portable system of claim 1 wherein the available codecs include a lossless codec and multiple lossy codecs, and the operation of determining the codec to use to process the visual content comprises selecting one of the lossless codec or one of the multiple lossy codecs.

6. The portable system claim 1 wherein the operations further comprise:
receiving an instruction sent by the host device; and
altering a function at the portable system according to the instruction.

7. The portable system of claim 6 wherein the function affects the operation of determining which of multiple available codecs to use to process the visual content.

8. The portable system of claim 6 wherein the portable system is configured for simultaneous bidirectional communications with the host device via a forward channel, by which the communication and visual content are sent by the processor to the host device, and a back channel by which the instruction sent by the host device to the processor.

9. The portable system of claim 1 further comprising a human-machine interface connected to the processor, wherein the operations further comprise:
receiving a user-input signal by way of the human-machine interface; and
performing, based on the user-input signal, at least one system programming routine selected from a group consisting of:
establishing a setting associated with a function of the portable system, and storing the setting to the storage device; and
altering a setting stored previously at the memory device.

10. The portable system of claim 1 wherein:
the host device is a part of an automobile comprising a universal serial bus (USB) port;
the portable system comprises a USB plug for mating with the USB port of the automobile; and
the computer-executable code comprises a USB mass-storage-device-class computing protocol, or a more-advanced device class protocol, for use in sending the communication and the visual content to the host device.

11. A host system comprising:
a processor configured to communicate with a communication port and a display screen device; and
a non-transitory storage device comprising computer-executable code that, when executed by the processor, causes the processor to perform operations comprising:
performing a handshake function with a portable system having a communication plug connected to the communication port;
receiving, from the portable system, a communication indicating (i) a codec selected at the portable system based on a subject application present at the portable system and/or the host device, and (ii) a codec parameter also selected at the portable system based on the application;
receiving visual content from the portable system;
processing the visual content using the codec and the codec parameter received, yielding processed visual content; and
publishing the processed visual content using the display screen device.

12. The host system of claim 11 wherein the codec parameter comprises at least one of a compression ratio and a resolution.

13. The host system of claim 11 wherein the codec is a lossless codec or a lossy codec.

14. The host system of claim 11 wherein the host system is configured for implementation as a part of an automobile comprising the communication port and the display screen device and the portable system comprises a communication mass-storage-device-class computing protocol, or a more-advanced device class protocol, for use in communications between the portable system and the processor.

15. The host system of claim 11 further comprising a human-machine interface connected to the processor, wherein the operations further comprise:
receiving, by way of the human-machine interface, a user-input signal; and
generating, based on the user-input signal, an instruction for altering a function of the portable system; and
sending the instruction to the portable system for altering the function of the portable system.

16. The host system of claim 15 wherein the function affects selection of the codec at the portable system in selecting the codec.

17. The host system of claim 15 wherein the host system is configured for simultaneous bidirectional communications with the portable system via a forward channel, by which the communication and the visual content from the portable system are received at the processor, and a back channel by which the instruction is sent by the processor to the portable system.

18. The host system of claim 15 wherein the function affects selection at the portable system of the codec and the codec parameter.

19. A non-transitory computer-readable storage device comprising a computer-executable code that, when executed by a processor, causes the processor to perform operations comprising:
receiving, from a source, a media file comprising visual content;
determining an application characteristic selected from a group consisting of an application identity and an application category associated with an application to be used in presenting the visual content;
determining, based on the application characteristic, which of multiple available codecs a host device should use to process the visual content;
sending, to the host device, a communication indicating the codec for use in processing the visual content; and
sending the visual content to the host device for display rendering using the codec determined.

20. The non-transitory computer-readable storage device of claim 19 wherein the operations further comprise:
determining, based on the application characteristic, which of multiple available codec parameters to use in processing the visual content; and
sending, to the host device, a communication indicating the codec parameter to be used in processing the visual content.
